(19) United States
(12) Patent Application Publication
(10) Pub. No.: US 2022/0004681 A1
(43) Pub. Date: Jan. 6, 2022

(54) MULTIDIMENSIONAL PERFORMANCE OPTIMIZATION DESIGN DEVICE, METHOD AND RECORDING MEDIUM

(71) Applicant: TOYOTA JIDOSHA KABUSHIKI KAISHA, Aichi-ken (JP)

(72) Inventor: Kohei SHINTANI, Nisshin-shi (JP)

(21) Appl. No.: 17/335,080

(22) Filed: Jun. 1, 2021

(30) Foreign Application Priority Data
Jul. 1, 2020 (JP) 2020-114384

(51) Int. Cl. G06F 30/20; G06F 30/15

(52) U.S. Cl. CPC G06F 30/20; G06F 2111/08; G06F 30/15

(57) ABSTRACT

A multidimensional performance optimization design device that includes: complement respective discrete observation values acquired by simulation for each of a plurality of performance dimensions, and output continuous prediction values and prediction errors in each of the plurality of performance dimensions; based on the prediction values and the prediction errors, compute, for each of the plurality of performance dimensions, a plurality of calculation points for searching a region where each of the plurality of performance dimensions is feasible; at the plurality of computed calculation points, compute, for each of the plurality of performance dimensions, a probability distribution for which each of the plurality of performance dimensions is feasible; and output, as a multidimensional performance feasible region, a general product from multiplying together the respective probability distributions computed for each of the plurality of performance dimensions.

### CROSS-REFERENCE TO RELATED APPLICATION

This application is based on and claims priority under 35 USC 119 from Japanese Patent Application No. 2020-114384 filed on Jul. 1, 2020, the disclosure of which is incorporated by reference herein.

### BACKGROUND

### Technical Field

The present disclosure relates to a multidimensional performance optimization design device, a multidimensional performance optimization design method that are related to designing a structural body of a vehicle body or the like and a recording medium recording a multidimensional performance optimization design program.

### Related Art

A key issue in structural body design is the establishment of design techniques capable of optimizing plural dimensions of performance (multidimensional performance), such as strength, rigidity, weight reduction, and vibration suppression, sometimes in cases in which such performance dimensions conflict with one another. Research is ongoing into simultaneous and parallel optimization of multidimensional performance using computer simulations.

Japanese Patent Application Laid-Open (JP-A) No. 2010-55466 discloses an invention relating to a product optimization design system capable of analyzing and evaluating changes in design evaluation indicators to find product performance and cost etc. by using a set base design method to find design solutions as an assembly related to multidimensional performance considering various uncertainties.

However, in the technology of JP-A No. 2010-55466, a search space grows exponentially as the number of dimensions of a problem relating to multidimensional performance increases. This presents the issue of the burgeoning computation costs incurred to compute a multidimensional performance feasible region.

Moreover, in the technology of JP-A No. 2010-55466, for cases in which there are few feasible solutions appropriate to the conditions, one issue that arises is the difficulty in obtaining information relating to the boundary of a feasible region for multidimensional performance, and another issue is the difficulty in sampling a new variable related to an additional multidimensional performance condition.

### SUMMARY

An aspect of the present disclosure is a multidimensional performance optimization design device that includes: a memory; and a processor coupled to the memory, the processor being configured to: complement respective discrete observation values acquired by simulation for each of a plurality of performance dimensions, and output continuous prediction values and prediction errors in each of the plurality of performance dimensions; based on the prediction values and the prediction errors, compute, for each of the plurality of performance dimensions, a plurality of calculation points for searching a region where each of the plurality of performance dimensions is feasible; at the plurality of computed calculation points, compute, for each of the plurality of performance dimensions, a probability distribution for which each of the plurality of performance dimensions is feasible; and output, as a multidimensional performance feasible region, a general product from multiplying together the respective probability distributions computed for each of the plurality of performance dimensions.

### BRIEF DESCRIPTION OF DRAWINGS

FIG. 1 is a block diagram illustrating an example of a configuration of a multidimensional performance optimization design device according to an exemplary embodiment.

FIG. 2 is a functional block diagram illustrating a CPU of a multidimensional performance optimization design device according to an exemplary embodiment.

FIG. 3 is a schematic diagram illustrating a hierarchy for design and verification in multidimensional performance optimization design according to an exemplary embodiment.

FIG. 4 is a conceptual diagram illustrating system design in an exemplary embodiment.

FIG. 5 is a flowchart illustrating an example of a flow for feasible region derivation by machine learning according to an exemplary embodiment.

FIG. 6 is a schematic diagram illustrating an example of a one-dimensional function regression employing Gaussian process regression.

FIG. 7 illustrates an example of a probability distribution for a constraint condition derived by Gaussian process regression.

FIG. 8 is a schematic diagram illustrating an example of results calculated by an acquisition function a_{PoF}(x).

FIG. 9 is a schematic diagram illustrating an example of results calculated by an acquisition function a_{ES}(x).

FIG. 10 is a schematic diagram illustrating an example of results calculated by a hybrid acquisition function a_{PoF-ES}(x).

FIG. 11 is an explanatory diagram illustrating a concept of simultaneous probability distribution computation.

### DESCRIPTION OF EMBODIMENTS

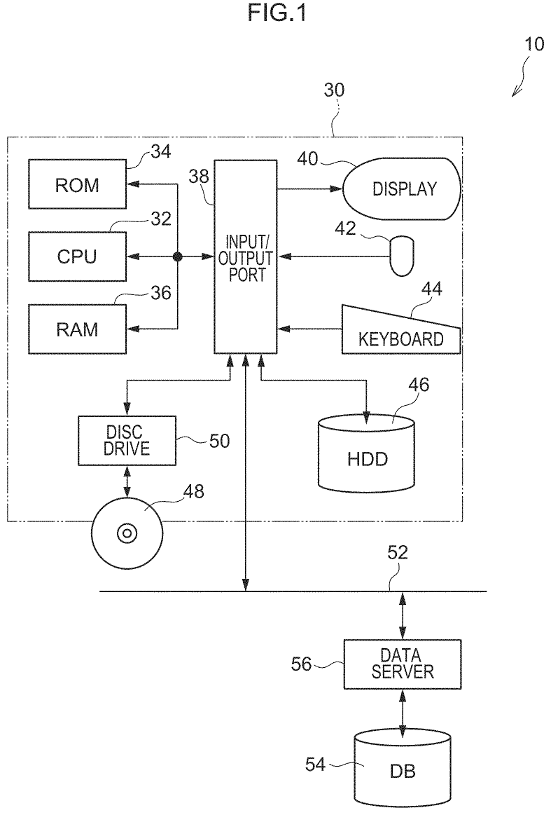

Explanation follows regarding a multidimensional performance optimization design device and a multidimensional performance optimization design method according to an exemplary embodiment, with reference to FIG. 1. FIG. 1 is a block diagram illustrating an example of a specific configuration of a multidimensional performance optimization design device 10 according to an exemplary embodiment of the present invention.

The multidimensional performance optimization design device 10 is configured including a computer 30. The computer 30 includes a CPU 32, this being an example of a hardware processor, ROM 34 and RAM 36, examples of memory, and an input/output port 38. As an example, the computer 30 is preferably a machine capable of executing advanced computational processing at high speed, such as an engineering workstation, a supercomputer, or the like.

The CPU 32, the ROM 34, the RAM 36, and the input/output port 38 of the computer 30 are connected together through various buses, for example an address bus, a data bus, and a control bus. A display 40, a mouse 42, a keyboard 44, a hard disk (HDD) 46, and a disc drive 50 to read information from various discs (for example CD-ROMs and DVDs) 48 are each connected to the input/output port 38 as various types of input/output device.

A network 52 is connected to the input/output port 38, and the input/output port 38 is capable of exchanging information with various devices connected over the network 52. In the present exemplary embodiment, a database (DB) 54-connected data server 56 is connected to the network 52 so as to enable the exchange of information with the DB 54.

The DB 54 is stored in advance with data relating to multidimensional performance optimization design and the like. Storage of information in the DB 54 may be executed using the computer 30 and the data server 56, or may be executed using another device connected to the network 52.

In the present exemplary embodiment, explanation is given regarding a case in which multidimensional performance optimization design data and the like is stored in the DB 54 connected to the data server 56. Alternatively, the information of the DB 54 may be stored in the inbuilt HDD 46 of the computer 30 or in an external storage device such as an external hard disk.

The HDD 46 of the computer 30 is installed with a multidimensional performance optimization design program to perform multidimensional performance optimization design. In the present exemplary embodiment, the CPU 32 executes multidimensional performance optimization design by loading and executing the multidimensional performance optimization design program. The CPU 32 also displays processing results of the multidimensional performance optimization design program on the display 40. Note that the multidimensional performance optimization design program of the present exemplary embodiment may be installed in the computer 30 by any of a number of methods. For example, the multidimensional performance optimization design program may be stored together with an installer program on a non-transitory computer-readable recording medium such as a CD-ROM or DVD. Then when a disc such as a CD-ROM or DVD is set in the disc drive 50 the installer program is executed on the CPU 32, and the multidimensional performance optimization design program is installed in the HDD 46, this being an example of a non-transitory computer-readable recording medium or memory. Alternatively, the multidimensional performance optimization design program may be installed in the HDD 46 by communicating with another information processing device connected to the computer 30 over a public telephone network or over the network 52.

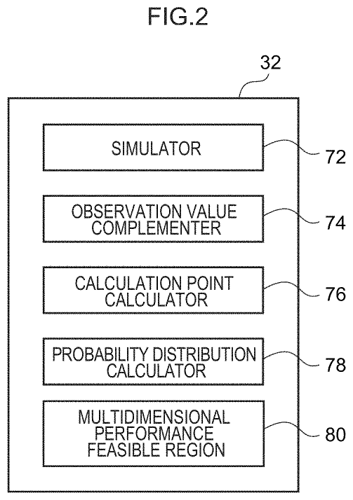

FIG. 2 is a functional block diagram illustrating the CPU 32 of the multidimensional performance optimization design device 10. Explanation follows regarding various functionality implemented by the CPU 32 of the multidimensional performance optimization design device 10 loading and executing the multidimensional performance optimization design program. The multidimensional performance optimization design program includes a simulation function to acquire observation values for each of plural performance dimensions by simulation, an observation value completion function to complete the acquired discrete observation values and output continuous prediction values and prediction errors in each of the plural performance dimensions, a calculation point computation function to compute plural calculation points where a search is to be made for a region where each of the plural performance dimensions is feasible, a probability distribution computation function to, at the plural calculation points, compute a probability distribution for where each of the plural performance dimensions is feasible, and a multidimensional performance feasible region output function to output as a multidimensional performance feasible region a general product from multiplying the respective probability distributions computed for each of the plural performance dimensions together. By executing the multidimensional performance optimization design program including each of these functions, the CPU 32 functions as a simulator 72, an observation value complementer 74, a calculation point calculator 76, a probability distribution calculator 78, and a multidimensional performance feasible region outputter 80, as illustrated in FIG. 2.

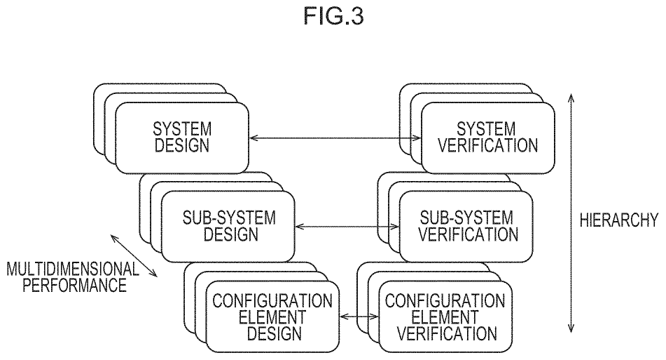

FIG. 3 is a schematic diagram illustrating a design and verification hierarchy in multidimensional performance optimization design according to the present exemplary embodiment. Designing a structural body of a vehicle or the like relies on the design of a system configuring the overall structural body, the design of a sub-system that is a lower section structure of the structural body, and the design of configuration elements such as components configuring the lower section structure of the sub-system. In multidimensional performance optimization design, feasible regions are derived at the system, sub-system, and configuration element levels where each of plural different, and sometimes conflicting, performance dimensions are optimizable, such as strength, rigidity, weight reduction, and vibration suppression. The appropriateness of a feasible region where design is optimized for multidimensional performance is checked by verification, and redesign is performed in cases in which this verification determines the feasible region to be unsuitable. The results of such redesign are then subjected to reverification to determine whether or not the feasible region is now appropriate.

This design and verification is performed at each of the configuration element, sub-system, and system levels. In multidimensional performance optimization design, generally the feasible regions are derived according to the following procedure. First, a model linking variables related to a performance dimension to responses to these variables is defined. Next, candidates for a feasible region are acquired by random sampling on the previously defined model. Then samples are extracted from the acquired results where response constraint conditions are met. Although in principle this procedure is straightforward, as the number of dimensions of the design variables increases, the space to be searched grows exponentially, and issues arise therefrom due to burgeoning computation costs.

In the present exemplary embodiment, the multidimensional performance feasible region is derived using a set base concurrent design method that employs machine learning (active learning). Employing machine learning enables an exponential increase in computation costs to be suppressed.

In the present exemplary embodiment, the feasible region is expressed as a probability distribution, thus enabling feasible regions to be found independently for individual performance dimensions of multidimensional performance. Moreover, multiplying the respective feasible regions for the individual performance dimensions together enables the multidimensional performance feasible region to be derived simply. Moreover, even in cases in which a new constraint condition is imposed, a probability distribution for this new constraint condition can be derived independently. Multiplying this derived probability distribution together with the multidimensional performance feasible region described above then enables derivation of a multidimensional performance feasible region that takes the new constraint condition into consideration.

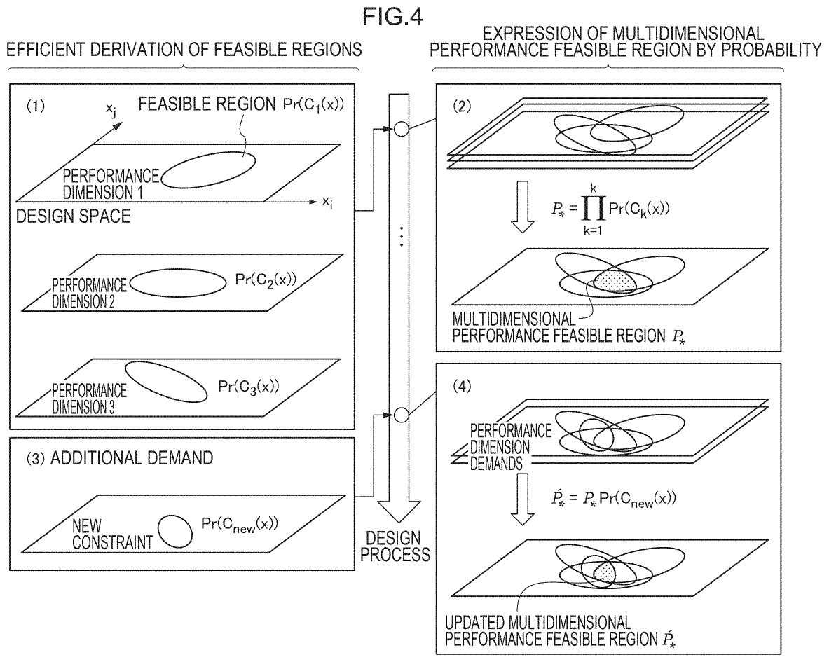

FIG. 4 is a conceptual diagram illustrating system design of the present exemplary embodiment. (1) in FIG. 4 illustrates an initial design stage, in which feasible regions that satisfy constraint conditions for each performance dimension, these being a performance dimension 1, a performance dimension 2, and a performance dimension 3, are efficiently derived as probability distributions Pr (Cᵢ(x)) (wherein i=1, 2, or 3). In the present exemplary embodiment, since Pr (Cᵢ(x)) expresses a probability relating to achieving each of the performance dimensions i, this leads to the following relationship. Note that Cᵢ(x) is a Boolean function with a variable x.

0≤Pr(Cᵢ(x))≤1

(2) in FIG. 4 illustrates an example of a representation of a multidimensional performance feasible region using probabilities. As described above, since the probability distributions of achievement in the respective performance dimensions 1 to 3 are Pr (Cᵢ(x)), the multidimensional performance feasible region, this being a region of simultaneous achievement in the performance dimensions 1 to 3, is expressed by the general product from multiplying the probability distributions for all the respective performance dimensions together.

(3) in FIG. 4 illustrates a case in which an additional demand to a specification has been made such as when, for example, a product is heading toward production after already being designed. Pr (C_{new}(x)) is derived as a probability distribution of achieving a new constraint relating to the additional demand.

(4) in FIG. 4 illustrates a case in which the multidimensional performance feasible region is updated with the additional demand. As described above, since Pr (C_{new}(x)) is the probability distribution relating to the new constraint, the multidimensional performance feasible region can be updated by multiplying the multidimensional performance feasible region derived in (2) of FIG. 4 together with Pr (C_{new}(x)).

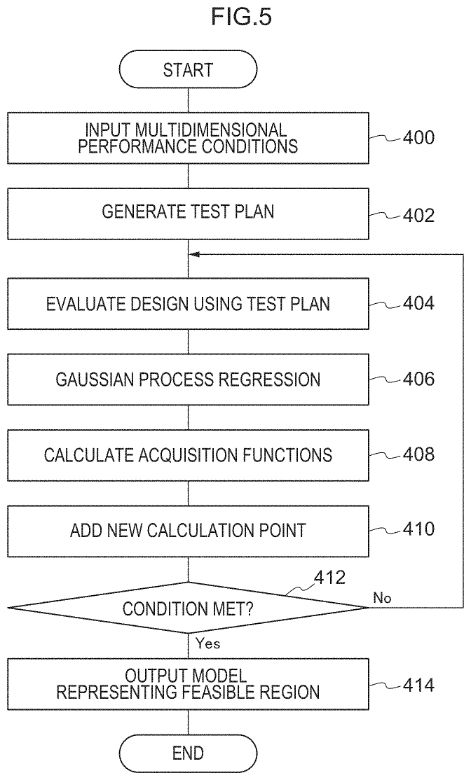

FIG. 5 is an example of a flowchart relating to deriving a feasible region by machine learning in the present exemplary embodiment. At step 400, conditions for achieving multidimensional performance are input. A constraint function gᵢ(x) such as that given below is an example of conditions input at step 400 for respective performance dimensions of multidimensional performance. The suffix i in this constraint function is an index for performance dimension in multidimensional performance, and K is the number of performance dimensions configuring the multidimensional performance.

gᵢ(x)≤0, i∈{1,2, . . . ,K}

The probability of each performance dimension of the multidimensional performance being feasible is expressed by Equation (1) below. As described above, the term Cᵢ(x) on the left side of Equation (1) is a Boolean function with the variable x. δᵢ on the right side of Equation (1) is a small positive value representing permissible error.

Pr( [symbol] ᵢ(x))=Pr(gᵢ(x)<0)≥1−δᵢ (1)

The multidimensional performance feasible region, this being a region in which performance dimensions i (i=1, 2, . . . , K) can be achieved simultaneously, is expressed by Equation (2) below as the general product from multiplying the respective probabilities for each performance dimension together.

$$\text{?} = {\prod }_{i = 1}^{K} Pr ( {𝒞}_{i} ( x ) ) \\ \text{?} \text{indicates text missing or illegible when filed} \qquad ( 2 )$$

At step 402, a test plan is generated to derive a feasible region where a multidimensional performance y is feasible, such as strength, rigidity, weight reduction, and vibration suppression, with respect to a variable x, such as a position on the structural body or an inertial moment acting on the structural body. At step 404, a design defined by the test plan is evaluated using computer aided engineering (CAE) simulations or the like. Discrete values corresponding to the variable x, such as values of y, are derived as observation values using simulation with CAE or the like.

At step 406, the observation values of y are predicted and completion is performed based on these predictions. A technique called Gaussian process regression is utilized in the present exemplary embodiment. Gaussian process regression is capable of completing and predicting the observation values y by considering the correlation of the observation values y to the variable x. Generally, Gaussian process regression models the correlation between the variable x and the observation values y as a Gaussian distribution, and so is not only able to complete the discrete observation values y probabilistically into a continuous function, but is also able to compute prediction errors thereof.

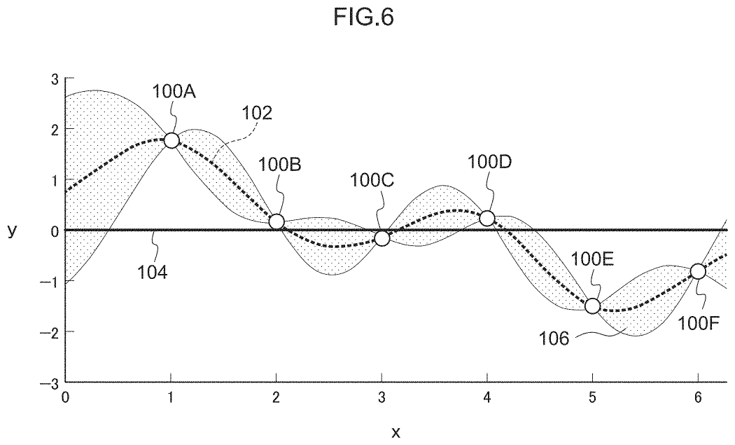

FIG. 6 is a schematic diagram illustrating an example of a one-dimensional function regression employing Gaussian process regression. FIG. 6 illustrates a curve 102 in which observation values 100A, 100B, 100C, 100D, 100E, 100F are hypothesized to be continuous. As illustrated in FIG. 6, the curve 102 is a continuous function corresponding to the variable x. The continuous nature of the function of the curve 102 means that not only can discrete data be completed and predicted, but differentiation with respect to variable x is also possible. Regions of prediction errors 106 are present around the periphery of the curve 102 in FIG. 6. The regions of the prediction errors 106 are narrower when the reliability of the prediction values illustrated by the curve 102 is higher, and are wider when the reliability is lower. An inequality constraint value 104 y=0 is illustrated, as an example, in FIG. 6. In the present exemplary embodiment, a feasible region is defined as a region in which the response y is smaller than the inequality constraint value 104.

In the present exemplary embodiment, the completed discrete data obtained by Gaussian process regression, the prediction errors 106, and the inequality constraint value 104 are employed to compute a cumulative distribution function (CDF) with respect to variable x.

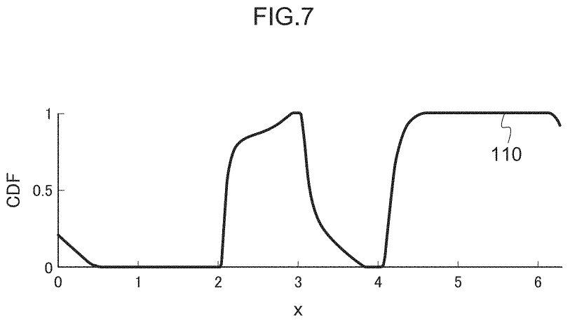

FIG. 7 illustrates an example of a constrained condition probability distribution derived by Gaussian process regression. The horizontal axis in FIG. 7 represents the variable x, and the vertical axis in FIG. 7 represents values of the cumulative distribution function CDF. A cumulative distribution function 110 in FIG. 7 indicates the probability of the value of y in FIG. 6 being the inequality constraint value 104 or lower. Using the cumulative distribution function Φ, Equation (1) above may be expressed as Equation (1A) below, and the probability distribution Pr (Ci(x)) for the variable x computed from the cumulative distribution function Φ. In the following Equations, b is a numerical value relating to a lower boundary 134, described later. Moreover, σ(x) in the following Equations is a prediction deviation computed by the calculation process in Gaussian process regression, and μ(x) is a prediction mean value. Using the Equation (1A) to compute a probability distribution for every point in a region (design space) relating to a position on a structural body, or a design defined by variable x such as an inertial moment acting on the structural would be impractical to due to the burgeoning computation costs incurred. Thus in the present exemplary embodiment calculation points where a search is to be made for a multidimensional performance feasible region are successively computed using acquisition functions, described later, and training data for machine learning is then updated using the information at these calculation points. A probability distribution for multidimensional performance attainment in the design space is then computed based on this updated training data.

$$Pr ( {𝒞}_{i} ( x ) ) = Pr ( {g}_{i} ( x ) < 0 ) = Φ ( \frac{b - μ ( x )}{σ ( x )} ) \qquad ( 1 A )$$

In the present exemplary embodiment, the results of Gaussian process regression (prediction values, prediction errors) are employed to compute the calculation points in design space where a search is to be made for a multidimensional performance feasible region. The calculation points may be found in the following manner.

At step 408, the acquisition functions are calculated. In the present exemplary embodiment, two acquisition functions having different characteristics are defined by the results of Gaussian process regression, and each of these acquisition functions is employed for a well-balanced search for calculation points.

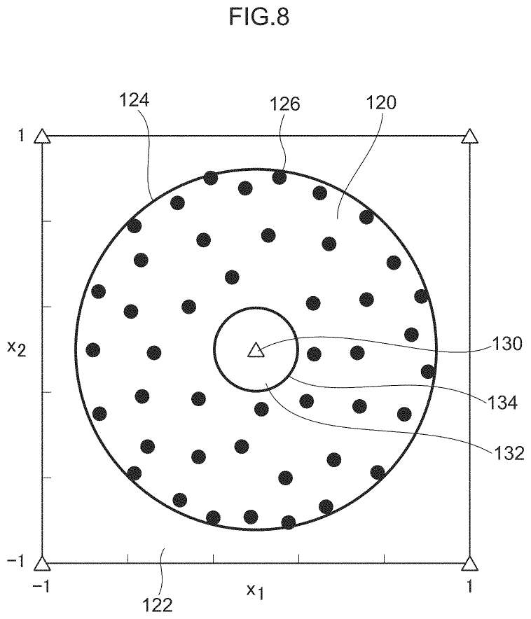

One of the acquisition functions is a probability of feasibility (PoF) a_{PoF}(x). a_{PoF}(x) is employed to search for calculation points lying inside the multidimensional performance feasible region. FIG. 8 is a schematic diagram illustrating an example of results calculated by a_{PoF}(x). FIG. 8 illustrates a feasible region 120 enclosed by an upper boundary 124 to a non-feasible region 122, and also illustrates another non-feasible region 132 present at the inside of the feasible region 120 on the other side of the lower boundary 134. In FIG. 8, feasible calculation points 126 are indicated by black circles, and non-feasible calculation points 130 are indicated by white triangles. As illustrated in FIG. 8, a_{PoF}(x) is better adapted for searching inside the feasible region 120 than searching in the vicinity of the upper boundary 124 or of the lower boundary 134. a_{PoF}(x) can be expressed by Equation (3) below.

$${a}_{PoF} ( x ) = {σ}^{2} ( x ) \{ Φ ( \frac{b - μ ( x )}{σ ( x )} ) - Φ ( \frac{a - μ ( x )}{σ ( x )} ) \} \qquad ( 3 )$$

In Equation (3), Φ is a cumulative distribution function, a is a numerical value relating to the upper boundary 124, and b is a numerical value relating to the lower boundary 134. Also in Equation (3): σ²(x) is the variance in prediction as computed by the calculation process of Gaussian process regression in searching for a feasible region under a condition of a<y<b; σ(x) is a prediction deviation, and μ(x) is a prediction mean value. In the present exemplary embodiment, a new calculation point is generated by maximizing a_{PoF}(x) in Equation (3).

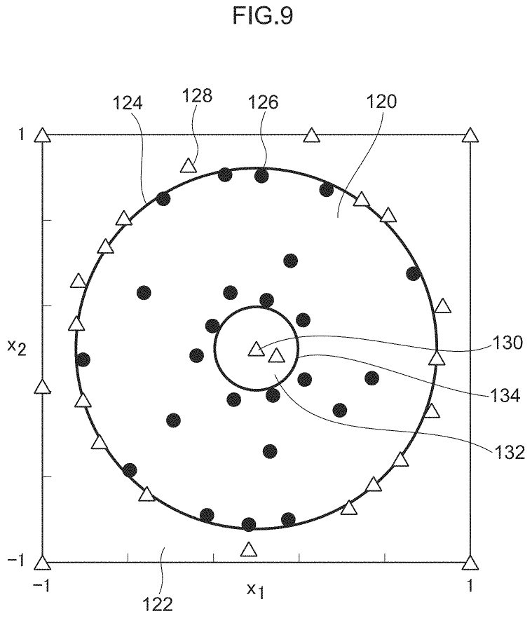

The other acquisition function is entropy search (ES) a_{ES}(x). a_{ES}(x) is employed to search for calculation points in the vicinity of the boundaries (upper boundary 124, lower boundary 134) between the feasible region 120 and the non-feasible regions 122, 132. FIG. 9 is a schematic diagram illustrating an example of results from calculation by a_{ES}(x). In FIG. 9, both the feasible calculation points 126 and non-feasible calculation points 128, 130 are present in the respective vicinities of the upper boundary 124 and the lower boundary 134, and so a_{ES}(x) is adapted to searching in the vicinity of the upper boundary 124 or of the lower boundary 134. a_{ES}(x) may be expressed by Equation (4) below. In Equation (4), H(p(f(x))) represents entropy (Shannon entropy).

$${a}_{E S} ( x ) = {σ}^{2} \{ 3 H ( p ( f ( x ) \vert 𝒟 , x ) ) - H ( p ( f ( x ) \vert 𝒟 , x , f ( x ) > b ) ) - H ( p ( f ( x ) \vert 𝒟 , x , a < f ( x ) < b ) ) - H ( p ( f ( x ) \vert 𝒟 , x , f ( x ) < a ) ) \} \qquad ( 4 )$$

Entropy can be calculated analytically for the following truncated Gaussian distributions in Equation (4).

p(f(x)| [symbol] ,x,f(x)>b),

p(f| [symbol] ,x,a≤f(x)>b),

p(f(x)| [symbol] ,x,f(x)<a)

In the present exemplary embodiment, a new calculation point is generated by maximizing a_{ES}(x) in Equation (4).

Although the two functions above are acquisition functions for the present exemplary embodiment, distinct processing for each of the respective functions would be needed were the two different acquisition functions to be employed. In the present exemplary embodiment, calculation points where a search for a feasible region is to be made are computed using an acquisition function a_{PoF-ES}(x) expressed by Equation (5) below.

a_{POF-ES}(x)=a_{PoF}(x)·a_{ES}(x) (5)

The right side of Equation (5) is the product of a_{PoF}(x) and a_{ES}(x). In the present exemplary embodiment, the acquisition function a_{PoF-ES}(x) expressed by Equation (5) is referred to as a hybrid acquisition function.

Equation (6) below is an Equation for generating a new calculation point (a new variable x). As expressed by Equation (6), a new calculation point x_{new} is computed as a point to maximize the hybrid acquisition function a_{PoF-ES}(x).

$${x}_{new} = {argmax }_{x ∈ X} {a}_{P O F - E S} ( x ) \qquad ( 6 )$$

Maximizing the hybrid acquisition function a_{PoF-ES}(x) enables the respective acquisition functions a_{PoF}(x), a_{ES}(x) to be maximized simultaneously without requiring separate computations to be performed for the respective acquisition functions a_{PoF}(x) and a_{ES}(x).

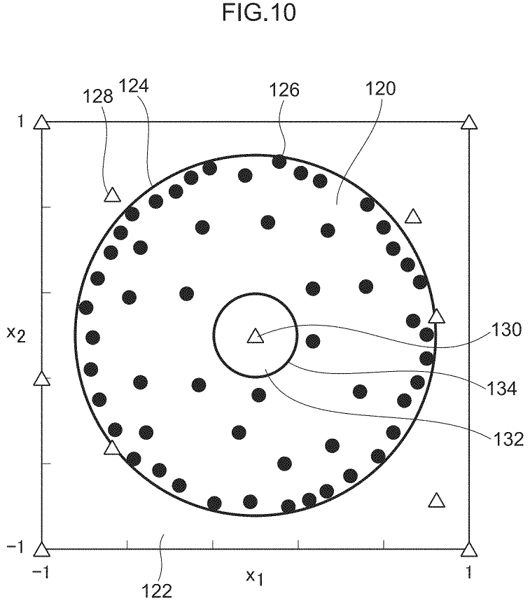

At step 410, the training data for machine learning is updated by adding the new calculation point that was computed using Equation (6) above to the training data. FIG. 10 is a schematic diagram illustrating an example of results from calculation by the hybrid acquisition function acquisition functions a_{PoF-ES}(x). In FIG. 10, feasible calculation points 126 are present not only inside the feasible region 120 but also in the vicinities of the upper boundary 124 and the lower boundary 134. Based on the updated training data, the feasible region 120 configured by the feasible calculation points 126 is then expressed by Equation (1A) as a probability distribution Pr (Cᵢ(x)) satisfying the constraint conditions for performance dimensions i (i=1, 2, . . . , K).

At step 412, determination is made as to whether or not a processing end condition has been met. The end condition of step 412 is defined by Equations (7), (8), and (9) below, with the end condition expressed by Equation (9) employed to determine whether the calculation has converged. Equation (9) represents a proportion occupied by a region where feasible/non-feasible cannot be adequately determined, as a proportion of an overall region, namely represents the proportion occupied by a region where calculation points have not been computed with respect to the design region. In Equation (8), δₖ is a small positive value representing permissible error. E on the right side of Equation (9) is a threshold representing the end condition and is a small positive value. The procedure transitions to step 414 in cases in which the processing end condition has been met at step 412. The procedure transitions to step 404 in cases in which the processing end condition has not been met at step 412, and computation of new calculation points is continued.

$$\begin{matrix}Z ( x ) = Φ ( \frac{b - μ ( x )}{σ ( x )} ) - Φ ( \frac{a - μ ( x )}{σ ( x )} ) & ( 7 ) \\ {v}_{k} ( x ) = \{ \begin{matrix}1 & ( {δ}_{k} \leq Z ( x ) \leq 1 - {δ}_{k} ) \\ 0 & ( Z ( x ) < {δ}_{k} , 1 - {δ}_{k} < Z ( x )\end{matrix} & ( 8 ) \\ \frac{\int {v}_{k} ( x ) d x}{\int d x} < ϵ & ( 9 )\end{matrix}$$

At step 414, a model representing the feasible region is output. As long as a feasible region for each performance dimension can be found as the probability distributions Pr (Cᵢ(x)), a multidimensional performance feasible region to satisfy all the performance dimension constraints can be simply found as a simultaneous probability distribution as in Equation (2) described above. Equation (2) is restated below.

$$\text{?} = {\prod }_{i = 1}^{K} Pr ( {𝒞}_{i} ( x ) ) \\ \text{?} \text{indicates text missing or illegible when filed} \qquad ( 2 )$$

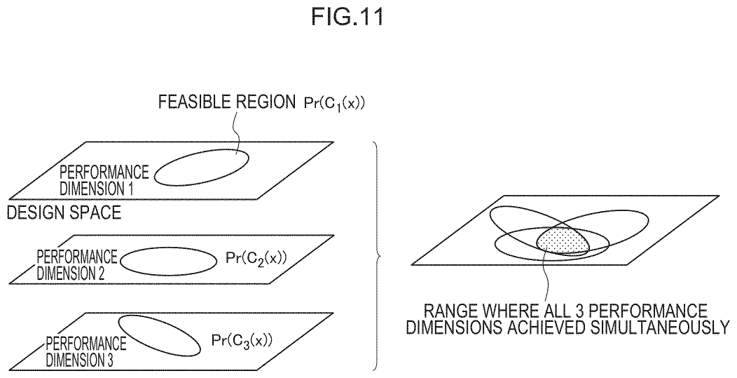

FIG. 11 is an explanatory diagram illustrating the concept of the simultaneous probability distribution computation expressed by Equation (2). FIG. 11 illustrates an example in which a multidimensional performance feasible region is derived for a case in which there are three specified performance dimensions, i.e. performance dimensions 1 to 3, and is an aggregation of the content depicted at (1) and (2) of FIG. 4. The multidimensional performance feasible region can be found by calculating a simultaneous probability distribution for the respective probability distributions. Moreover, this approach enables the determination of which constraints are the cause of a region not being in the multidimensional performance feasible region.

At step 414, the processing illustrated in FIG. 5 is ended after outputting the model representing the feasible region.

As described above, in the present exemplary embodiment, since discrete observation values obtained by simulation are completed and output as continuous prediction values, there is no need to derive numerous observation values by simulation. This enables the computation costs of simulation to be suppressed. Moreover, Gaussian process regression enables not only prediction values to be computed but also enables prediction errors to be computed. Calculation points where a search for the multidimensional performance feasible region is to be made are successively computed based on the computed prediction values and prediction errors.

Employing the hybrid acquisition function a_{PoF-ES}(x) capable of simultaneous searching at both the boundaries of the feasible region and inside the feasible region enables calculation points to be computed efficiently. The calculation points obtained thereby are then added to the training data for machine learning. A probability distribution for where each of the respective performance dimensions is feasible is then computed at each of the calculation points based on the updated training data.

The training data obtained by efficient computation using such a hybrid acquisition function a_{PoF-ES}(x) as in the present exemplary embodiment enables a significant reduction in computation costs in comparison to another method such as random sampling or the like.

Moreover, expressing the feasible regions as probability distributions in the present exemplary embodiment enables each of the respective performance dimensions to be expressed by continuous values having feasibility as the scale. Design pointers have hitherto been difficult to obtain in cases in which a feasible solution was not obtained, due to feasible regions being treated as binary expressions of feasible/non-feasible. The present exemplary embodiment enables design pointers to be obtained easily, for example giving pointers to regions where additional calculations have a good probability of being feasible, and eliminating the cost of calculation in regions where there is little probability of being feasible.

Moreover, since hitherto a feasible region (surface) has been estimated by looking at the grouping together of many feasible solution points, there has been the need for a high number of calculation points to predict the boundaries that form such a surface. However, in the present exemplary embodiment a feasible region is directly modeled, which enables the feasible region to be estimated directly.

Moreover, in the present exemplary embodiment, even in cases in which a new performance constraint has emerged, the multidimensional performance feasible region can be updated by multiplying a probability distribution relating to the new performance constraint together with a probability distribution representing the current multidimensional performance feasible region.

Note that “acquisition function a_{PoF}(x)” corresponds to a “first acquisition function”, “acquisition function a_{ES}(x)” corresponds to a “second acquisition function”, and “ε” corresponds to a “predetermined threshold”.

An object of the present disclosure is to enable a feasible region for multidimensional performance to be found efficiently.

A first aspect of the present disclosure is a multidimensional performance optimization design device that includes: a memory; and a processor coupled to the memory, the processor being configured to: complement respective discrete observation values acquired by simulation for each of a plurality of performance dimensions, and output continuous prediction values and prediction errors in each of the plurality of performance dimensions; based on the prediction values and the prediction errors, compute, for each of the plurality of performance dimensions, a plurality of calculation points for searching a region where each of the plurality of performance dimensions is feasible; at the plurality of computed calculation points, compute, for each of the plurality of performance dimensions, a probability distribution for which each of the plurality of performance dimensions is feasible; and output, as a multidimensional performance feasible region, a general product from multiplying together the respective probability distributions computed for each of the plurality of performance dimensions.

In the multidimensional performance optimization design device of the first aspect, the discrete observation values from simulation are completed and output as continuous prediction values. This means that there is no need to derive numerous observation values by simulation. This enables the computation costs of simulation to be suppressed as a result.

In the multidimensional performance optimization design device of the first aspect, the calculation points where a search is to be made for the multidimensional performance feasible region can be computed efficiently based on the computed prediction values and prediction errors.

Expressing the feasible regions as probability distributions in the multidimensional performance optimization design device of the first aspect enables the feasible regions to be expressed by continuous values having feasibility of the respective performance dimensions as the scale.

A second aspect of the present disclosure is the multidimensional performance optimization design device of the first aspect, wherein the processor is further configured to: in a case in which a new performance dimension constraint has emerged, complement discrete observation values acquired by simulation for the new performance dimension, and output continuous prediction values and prediction errors in the new performance dimension; based on the prediction values and the prediction errors for the new performance dimension, compute a plurality of calculation points for searching a region where the new performance dimension is feasible; at the plurality of calculation points for searching a region where the new performance dimension is feasible, compute a probability distribution for which the new performance dimension is feasible; and output, as a new multidimensional performance feasible region, a product from multiplying the general product of the probability distributions computed for each of the plurality of performance dimensions together with the probability distribution of feasibility in the new performance dimension.

In the multidimensional performance optimization design device of the second aspect, even in cases in which a new performance dimension constraint has emerged, the multidimensional performance feasible region can be updated by multiplying the probability distribution related to the new performance dimension constraint together with the probability distribution expressing the current multidimensional performance feasible region.

A third aspect of the present disclosure is the multidimensional performance optimization design device of the first or second aspect, wherein the processor is further configured to take, as the calculation point, a point maximizing a product from multiplying a first acquisition function related to search inside the feasible region together with a second acquisition function related to search in a vicinity of a boundary between the feasible region and a non-feasible region.

The multidimensional performance optimization design device of the third aspect enables calculation points to be computed by searching simultaneously at the boundaries of the feasible region and inside the feasible region.

A fourth aspect of the present disclosure is the multidimensional performance optimization design device of any of the first to third aspect, wherein the processor is further configured to end computation of the calculation points in a case in which a region, in which none of the calculation points are computed, is less than a predetermined threshold as a proportion with respect to an overall design region.

The multidimensional performance optimization design device of the fourth aspect enables setting of calculation points in the design region sufficient to identify the multidimensional performance feasible region.

A fifth aspect of the present disclosure is a multidimensional performance optimization design method performed by a processor, the method that includes: complementing respective discrete observation values acquired by simulation for each of a plurality of performance dimensions, and outputting continuous prediction values and prediction errors in each of the plurality of performance dimensions; based on the prediction values and the prediction errors, computing, for each of the plurality of performance dimensions, a plurality of calculation points for searching a region where each of the plurality of performance dimensions is feasible; at the plurality of computed calculation points, computing, for each of the plurality of performance dimensions, a probability distribution for which each of the plurality of performance dimensions is feasible; and outputting, as a multidimensional performance feasible region, a general product from multiplying together the respective probability distributions computed for each of the plurality of performance dimensions.

In the multidimensional performance optimization design method of the fifth aspect, the discrete observation values acquired by simulation are completed and output as continuous prediction values. This means that there is no need to derive numerous observation values by simulation. This enables the computation costs of simulation to be suppressed.

In the multidimensional performance optimization design method of the fifth aspect, the calculation points where a search is to be made for the multidimensional performance feasible region can be computed efficiently based on the computed prediction values and prediction errors.

Expressing the feasible regions as probability distributions in the multidimensional performance optimization design method of the fifth aspect enables the feasible regions to be expressed by continuous values having feasibility of the respective performance dimensions as the scale.

A sixth aspect of the present disclosure is the multidimensional performance optimization design method of the fifth aspect, wherein the method further includes: in a case in which a new performance dimension constraint has emerged, complementing discrete observation values acquired by simulation for the new performance dimension, and outputting continuous prediction values and prediction errors in the new performance dimension; based on the prediction values and the prediction errors for the new performance dimension, computing a plurality of calculation points for searching a region where the new performance dimension is feasible; at the plurality of calculation points for searching a region where the new performance dimension is feasible, computing a probability distribution for which the new performance dimension is feasible; and outputting, as a new multidimensional performance feasible region, a product from multiplying the general product of the probability distributions computed for each of the plurality of performance dimensions together with the probability distribution of feasibility in the new performance dimension.

In the multidimensional performance optimization design method of the sixth aspect, even in cases in which a new performance dimension constraint has emerged, the multidimensional performance feasible region can be updated by multiplying the probability distribution related to the new performance dimension constraint together with the probability distribution expressing the current multidimensional performance feasible region.

A seventh aspect of the present disclosure is the multidimensional performance optimization design method of the fifth or sixth aspect, wherein the method further comprises taking, as the calculation point, a point maximizing a product from multiplying a first acquisition function related to search inside the feasible region together with a second acquisition function related to search in a vicinity of a boundary between the feasible region and a non-feasible region.

The multidimensional performance optimization design method of the seventh aspect enables calculation points to be computed by searching simultaneously at the boundaries of the feasible region and inside the feasible region.

An eighth aspect of the present disclosure is the multidimensional performance optimization design method of any of the fifth to seventh aspect, wherein the method further includes ending computation of the calculation points in a case in which a region, in which none of the calculation points are computed, is less than a predetermined threshold as a proportion with respect to an overall design region.

The multidimensional performance optimization design method of the eighth aspect enables setting of calculation points in the design region that will be sufficient to identify the multidimensional performance feasible region. The first to the eighth aspects can be implemented in a form of a non-transitory computer-readable recording medium.

The present disclosure accordingly enables a multidimensional performance feasible region to be found efficiently.

1. A multidimensional performance optimization design device comprising:
a memory; and
a processor coupled to the memory, the processor being configured to:
complement respective discrete observation values acquired by simulation for each of a plurality of performance dimensions, and output continuous prediction values and prediction errors in each of the plurality of performance dimensions;
based on the prediction values and the prediction errors, compute, for each of the plurality of performance dimensions, a plurality of calculation points for searching a region where each of the plurality of performance dimensions is feasible;
at the plurality of computed calculation points, compute, for each of the plurality of performance dimensions, a probability distribution for which each of the plurality of performance dimensions is feasible; and
output, as a multidimensional performance feasible region, a general product from multiplying together the respective probability distributions computed for each of the plurality of performance dimensions.

2. The multidimensional performance optimization design device of claim 1, wherein the processor is further configured to:
in a case in which a new performance dimension constraint has emerged,
complement discrete observation values acquired by simulation for the new performance dimension, and output continuous prediction values and prediction errors in the new performance dimension;
based on the prediction values and the prediction errors for the new performance dimension, compute a plurality of calculation points for searching a region where the new performance dimension is feasible;
at the plurality of calculation points for searching a region where the new performance dimension is feasible, compute a probability distribution for which the new performance dimension is feasible; and
output, as a new multidimensional performance feasible region, a product from multiplying the general product of the probability distributions computed for each of the plurality of performance dimensions together with the probability distribution of feasibility in the new performance dimension.

3. The multidimensional performance optimization design device of claim 1, wherein the processor is further configured to take, as the calculation point, a point maximizing a product from multiplying a first acquisition function related to search inside the feasible region together with a second acquisition function related to search in a vicinity of a boundary between the feasible region and a non-feasible region.

4. The multidimensional performance optimization design device of claim 1, wherein the processor is further configured to end computation of the calculation points in a case in which a region, in which none of the calculation points are computed, is less than a predetermined threshold as a proportion with respect to an overall design region.

5. A multidimensional performance optimization design method performed by a processor, the method comprising:
complementing respective discrete observation values acquired by simulation for each of a plurality of performance dimensions, and outputting continuous prediction values and prediction errors in each of the plurality of performance dimensions;
based on the prediction values and the prediction errors, computing, for each of the plurality of performance dimensions, a plurality of calculation points for searching a region where each of the plurality of performance dimensions is feasible;
at the plurality of computed calculation points, computing, for each of the plurality of performance dimensions, a probability distribution for which each of the plurality of performance dimensions is feasible; and
outputting, as a multidimensional performance feasible region, a general product from multiplying together the respective probability distributions computed for each of the plurality of performance dimensions.

6. The multidimensional performance optimization design method of claim 5, wherein the method further comprises:
in a case in which a new performance dimension constraint has emerged,
complementing discrete observation values acquired by simulation for the new performance dimension, and outputting continuous prediction values and prediction errors in the new performance dimension;
based on the prediction values and the prediction errors for the new performance dimension, computing a plurality of calculation points for searching a region where the new performance dimension is feasible;
at the plurality of calculation points for searching a region where the new performance dimension is feasible, computing a probability distribution for which the new performance dimension is feasible; and
outputting, as a new multidimensional performance feasible region, a product from multiplying the general product of the probability distributions computed for each of the plurality of performance dimensions together with the probability distribution of feasibility in the new performance dimension.

7. The multidimensional performance optimization design method of claim 5, wherein the method further comprises taking, as the calculation point, a point maximizing a product from multiplying a first acquisition function related to search inside the feasible region together with a second acquisition function related to search in a vicinity of a boundary between the feasible region and a non-feasible region.

8. The multidimensional performance optimization design method of claim 5, wherein the method further comprises ending computation of the calculation points in a case in which a region, in which none of the calculation points are computed, is less than a predetermined threshold as a proportion with respect to an overall design region.

9. A non-transitory computer-readable recording medium that records a program that is executable by a computer to perform a multidimensional performance optimization design processing, the multidimensional performance optimization design processing comprising:
complementing respective discrete observation values acquired by simulation for each of a plurality of performance dimensions, and outputting continuous prediction values and prediction errors in each of the plurality of performance dimensions;
based on the prediction values and the prediction errors, computing, for each of the plurality of performance dimensions, a plurality of calculation points for searching a region where each of the plurality of performance dimensions is feasible;
at the plurality of computed calculation points, computing, for each of the plurality of performance dimensions, a probability distribution for which each of the plurality of performance dimensions is feasible; and
outputting, as a multidimensional performance feasible region, a general product from multiplying together the respective probability distributions computed for each of the plurality of performance dimensions.

10. The non-transitory computer-readable recording medium of claim 9, wherein the multidimensional performance optimization design processing further comprises:
in a case in which a new performance dimension constraint has emerged,
complementing discrete observation values acquired by simulation for the new performance dimension, and outputting continuous prediction values and prediction errors in the new performance dimension;
based on the prediction values and the prediction errors for the new performance dimension, computing a plurality of calculation points for searching a region where the new performance dimension is feasible;
at the plurality of calculation points for searching a region where the new performance dimension is feasible, computing a probability distribution for which the new performance dimension is feasible; and
outputting, as a new multidimensional performance feasible region, a product from multiplying the general product of the probability distributions computed for each of the plurality of performance dimensions together with the probability distribution of feasibility in the new performance dimension.

11. The non-transitory computer-readable recording medium of claim 9, wherein the multidimensional performance optimization design processing further comprises taking, as the calculation point, a point maximizing a product from multiplying a first acquisition function related to search inside the feasible region together with a second acquisition function related to search in a vicinity of a boundary between the feasible region and a non-feasible region.

12. The non-transitory computer-readable recording medium of claim 9, wherein the multidimensional performance optimization design processing further comprises ending computation of the calculation points in a case in which a region, in which none of the calculation points are computed, is less than a predetermined threshold as a proportion with respect to an overall design region.
